(19) United States
(12) Patent Application Publication
(10) Pub. No.: US 2026/0217331 A1
(43) Pub. Date: Jul. 30, 2026

(54) DUAL-MOTOR STRAIN WAVE GEAR CONTINUOUSLY VARIABLE TRANSMISSION

(71) Applicant: Fox Factory, Inc., Duluth, GA (US)

(72) Inventors: William O. Brown, IV, Aptos, CA (US); Bjorn Borgers, Vancouver (CA)

(21) Appl. No.: 19/037,562

(22) Filed: Jan. 27, 2025

(51) Int. Cl. B62M 6/55; B62M 11/14; F16H 49/00

(52) U.S. Cl. CPC B62M 6/55; B62M 11/145; F16H 49/001; F16H 2049/003

(57) ABSTRACT

An electric bicycle or other electric vehicle includes a frame, a wheel coupled to the frame, and a continuously variable transmission system mounted to the frame. The continuously variable transmission system includes a first motor, a second motor, and a strain wave gear mechanism operatively connected to both the first motor and the second motor. The strain wave gear mechanism includes a circular spline driven by the first motor, a wave generator driven by the second motor, and a flexspline configured to output power to the wheel. A controller independently controls the first motor and the second motor to achieve a desired reduction ratio. The first motor is operatively connected to the circular spline via a pinion gear. The strain wave gear mechanism can be integrated into a drive unit or gearbox positioned relative to a pedal crank assembly of the electric bicycle.

### TECHNICAL FIELD

The present disclosure relates to power transmission systems, and more particularly to a dual-motor strain wave gear continuously variable transmission for electric vehicles including, but not limited to, electric bicycles.

### BACKGROUND

Electric bicycles, or e-bikes, have gained popularity as an eco-friendly and efficient mode of transportation. These vehicles typically utilize human pedaling and/or electric motor assistance to propel the rider. Traditional e-bike drivetrains often incorporate multiple gears or a derailleur system to provide a range of gear ratios for different riding conditions. However, these systems can be complex, requiring regular maintenance and adjustment to function.

Continuously variable transmissions have emerged as an alternative to conventional geared systems in various applications, offering smooth and stepless power delivery across a range of ratios. Existing continuously variable transmission designs may face challenges in terms of size, weight, efficiency, or complexity when adapted for use in e-bike applications. There is a need for innovative transmission solutions that can enhance the performance and user experience of electric bicycles.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an electric bicycle is provided. The electric bicycle includes a frame, a wheel coupled to the frame, and a continuously variable transmission system (CVT) mounted to the frame. The continuously variable transmission system includes a first motor, a second motor, and a strain wave gear mechanism operatively connected to both the first motor and the second motor. The strain wave gear mechanism includes a circular spline driven by the first motor, a wave generator driven by the second motor, and a flexspline configured to output power to the wheel.

The electric bicycle may further include a controller configured to control the first motor and the second motor to achieve a desired reduction ratio. The electric bicycle may further include a chainring and a crank, where the strain wave gear mechanism can be operatively coupled to the chainring, and the chainring and the crank can be configured to spin at different speeds. The first motor can be operatively connected to the circular spline. The controller, in some aspects, can be configured to perform at least one of: adjusting a gear ratio output by the transmission system by correspondingly driving the first motor, and providing power to assist an operator by correspondingly driving the second motor.

According to another aspect of the present disclosure, a continuously variable transmission (CVT) system is provided. The continuously variable transmission system includes a first motor, a second motor, and a strain wave gear mechanism operatively connected to both the first motor and the second motor. The strain wave gear mechanism includes a circular spline, a wave generator, and a flexspline. The first motor is configured to drive the circular spline and the second motor is configured to drive the wave generator to provide variable reduction ratios.

The first motor can be operatively connected to the circular spline. The flexspline can be operatively connected to an output shaft. The continuously variable transmission system can further include a gear connected between the flexspline and the output shaft. The continuously variable transmission may further include a controller configured to independently control the first motor and the second motor by adjusting the speeds of the first motor and the second motor to achieve a desired reduction ratio in a range of predetermined reduction ratios.

The continuously variable transmission system can further include a chainring and a crank. The strain wave gear mechanism can be operatively coupled to the chainring, and the chainring and the crank may be configured to spin at different speeds. The continuously variable transmission system can further include a controller configured to adjust a rotational speed of the chainring by adjusting an output of the first motor. The output of the first motor can include one or more of speed, power, and torque. The second motor can be configured to provide an output, which can also include one or more of speed, power, and torque. For example, the second motor can be configured to output power to match a pedaling speed (e.g., a speed at which an operator is pedaling) to provide support.

The continuously variable transmission system can further include a controller configured to perform at least one of: adjusting a gear ratio output by the transmission system by correspondingly driving the first motor, or providing power to assist an operator by correspondingly driving the second motor. The continuously variable transmission system can further include a crank spindle operatively connected to the wave generator, where movement of the crank spindle can drive the wave generator, where a reduction ratio may be provided between one or more of: the second motor and the flexspline, or where a reduction ratio can be provided between the crank spindle and the flexspline, or where a reduction ratio may be provided between both, e.g., between the second motor and the flexspline, and between the crank spindle and the flexspline.

According to another aspect of the present disclosure, a continuously variable transmission (CVT) system is provided. The continuously variable transmission system includes a first motor, a second motor, a crank spindle, and a strain wave gear mechanism operatively connected to the first motor, the second motor, and the crank spindle. The strain wave gear mechanism includes a circular spline, a wave generator, and a flexspline. The first motor can be configured to drive the circular spline and at least one of the second motor or the crank spindle, or both, and is configured to drive the wave generator to provide variable reduction ratios.

The strain wave gear mechanism can be operatively coupled to the chainring. The continuously variable transmission system can further include a crank, where the chainring and the crank can be configured to spin at different speeds. The continuously variable transmission system can further include a controller configured to adjust a rotational speed of the chainring by adjusting an output of the first motor. The controller can be configured to perform at least one of: adjusting a gear ratio using the first motor based on a speed or other output of the first motor, providing power to assist an operator using the second motor, or a combination thereof. The continuously variable transmission system can further include a crank spindle operatively connected to the wave generator, where movement of the crank spindle may drive the wave generator, where a reduction ratio may be provided between one or more of: the second motor and the flexspline, or where a reduction ratio can be provided between the crank spindle and the flexspline, or where a reduction ratio may be provided between both, e.g., between the second motor and the flexspline, and between the crank spindle and the flexspline.

According to another aspect of the present disclosure, a method of operating a continuously variable transmission system for an electric bicycle is provided. The method includes driving a circular spline of a strain wave gear mechanism with a first motor, driving a wave generator of the strain wave gear mechanism with a second motor (independent of the first motor), and outputting power through a flexspline of the strain wave gear mechanism. The driving of the circular spline and the wave generator provides variable reduction ratios.

The method can further include controlling the first motor and the second motor independently to achieve a desired reduction ratio. Controlling the first motor and the second motor can include adjusting their respective speeds using a controller mounted on a handlebar of an electric bicycle or other processing circuitry of a vehicle. The method can further include transmitting power from the flexspline to an output shaft through a gear. Driving the circular spline can include driving a pinion gear operatively connected to the circular spline with the first motor. The strain wave gear mechanism can be integrated into a drive unit positioned above a pedal crank assembly of the electric bicycle.

The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of an electric vehicle according to various embodiments of the present disclosure.

FIG. 2 illustrates a schematic block diagram of a strain wave gear continuously variable transmission system according to various embodiments of the present disclosure.

FIG. 3 illustrates a front view of a strain wave gear assembly according to various embodiments of the present disclosure.

FIG. 4 illustrates a multitude of front views of a strain wave gear assembly at different rotational positions according to various embodiments of the present disclosure.

FIG. 5 illustrates an isometric view of a dual motor strain wave gear continuously variable transmission system according to various embodiments of the present disclosure.

FIG. 6 illustrates a flowchart depicting a process for controlling a dual motor strain wave gear continuously variable transmission system according to various embodiments of the present disclosure.

FIGS. 7 and 8 are schematic block diagram of another embodiment of a strain wave gear continuously variable transmission system according to various embodiments of the present disclosure.

### DETAILED DESCRIPTION

The present disclosure relates to a power transmission for use in electric vehicles and, in some implementations, electric bicycles. Electric bicycles, often referred to as e-bikes, are increasingly popular modes of transportation that combine human pedaling with electric motor assistance. To accommodate varying riding conditions and rider preferences, these vehicles typically require a mechanism to adjust the level of torque. Traditional systems often employ multiple gears or a derailleur system, which can be complex and require regular maintenance.

In response to these challenges, the present disclosure discloses a dual-motor strain wave gear continuously variable transmission (CVT) system. The transmission system is adapted to offer smooth and stepless power delivery across a range of ratios, enhancing the performance and user experience of electric bicycles. The transmission system can include two motors, a circular spline, a wave generator, and a flexspline, referred to collectively as a strain wave gear (SWG).

Strain wave gears, also known as harmonic drives, are a type of gear mechanism that can provide high gear reduction ratios in a relatively compact form factor or package. Strain wave gears typically include a wave generator, a flexspline, and a circular spline. The wave generator is an elliptical or oval-shaped component that fits inside the flexspline, which is generally a thin, flexible cylinder with external gear teeth. The circular spline is a rigid outer ring with internal gear teeth that mesh with the flexspline.

The operation of a harmonic drive relies on the principle of wave generation. As the wave generator (which is non-circular or oval-shaped) rotates, it causes the flexspline to deform and engage with the circular spline at specific points. This deformation creates a “wave” that travels around the circumference of the flexspline. The difference in the number of teeth between the flexspline and the circular spline results in a gear reduction, typically with the flexspline having fewer teeth than the circular spline.

Strain wave gears can offer several advantages. Strain wave gears can achieve high reduction ratios in a single stage, often exceeding a 100:1 ratio. This can allow for precise control and high torque output in a compact form factor such that a transmission system would not be overly heavy or utilize too much space. Additionally, strain wave gears have minimal backlash, which can be beneficial in applications requiring high precision.

According to various embodiments, a first motor of a vehicle (e.g., a bicycle) is configured to drive a circular spline of a strain wave gear, which is typically static in conventional strain wave gear mechanisms, whereas a second motor is configured to drive a wave generator of the strain wave gear. The flexspline, driven by the wave generator, is configured to output power, which can be applied to a pedal system, a gearing system, a battery, and so forth, of a suitable electric vehicle.

By independently or separately controlling the two motors using suitable control signals (e.g., alternating current (AC) or direct current (DC) motor driving signals), the transmission system can achieve a continuously variable set of reduction ratios, thereby providing a wide range of output speeds and/or torque settings. This dual-motor strain wave gear continuously variable transmission system may offer a high torque capability, high gear reduction, and high efficiency out of a single stage, simplifying the design and maintenance of electric bicycles and offering variable ride settings and improving performance.

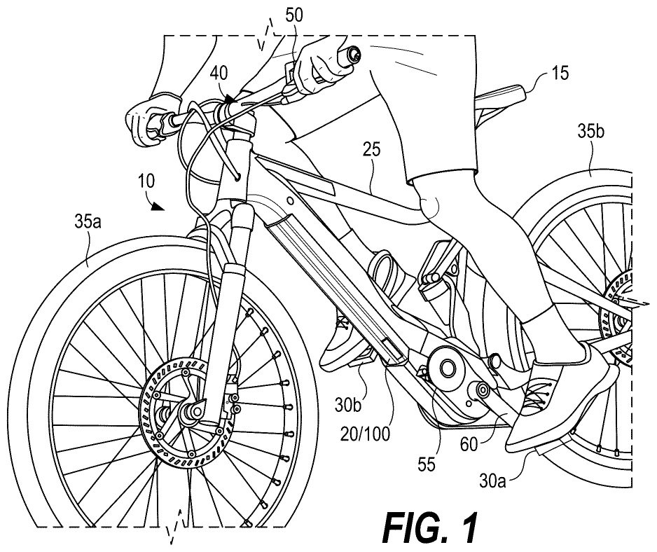

Referring to FIG. 1, a perspective view of an electric vehicle 10, which can be an electric bicycle in some aspects, is shown according to various embodiments. The electric vehicle 10 includes a frame 25 that supports various components. For instance, a seat 15 can be mounted on the upper portion of the frame 25. The electric vehicle 10 can further include a front wheel 35a and a rear wheel 35b similarly mounted to the frame 25.

A handlebar 40 can be attached to the front of the frame 25 for steering the electric vehicle 10. In some cases, a controller 50 is mounted on the handlebar 40, where a lever, button, or other input device of the controller 50 is actuatable or manipulatable, sometimes during operation of the vehicle 10. For instance, the lever or other actuator of the controller 50 allows the rider to control various functions of the vehicle 10 using hand movements, such as finger flicks or thumb flicks. The controller 50 can interact with processing circuitry of the bicycle to adjust ride settings, as will be described.

While various embodiments herein show the controller 50 on the handlebar 40, the disclosure is not so limited. The controller 50 can be in a multitude of locations including, but not limited to, a location adjacent the pedals that enables foot manipulation instead of hand or thumb manipulation, and so forth.

In any event, the controller 50 can be configured to alternate between various predefined settings which, in turn, may cause processing circuitry of the vehicle 10 to independently control a first motor 105 and a second motor 110 to achieve or output a desired reduction ratio. In some aspects, controlling the first motor 105 and the second motor 110 comprises adjusting their respective outputs. The outputs of the first motor 105 and/or the second motor 110 can include speed, power, torque, and so forth. For instance, the processing circuitry can generate two different motor control signals, each controlling the first motor 105 and the second motor 110, respectively. In some embodiments, the processing circuitry generally controls a speed output by the first motor 105 and power output by the second motor 110.

Different ride settings can be predetermined in the controller 50, which can be iterated through using a lever or other input device. For instance, the different ride settings can be specified in an application-specific integrated circuit (ASIC), stored in memory of a field-programmable gate array (FGPA), stored in memory or a computing device, and so forth. Manipulation of the lever of the controller 50 or other input device can direct processing circuitry of the vehicle 10 to iterate between the different ride settings, which can iterate through different predetermined signals to provide to the first motor 105 and the second motor 110 to achieve one of a range of desired reduction ratios, increased assistance or power provided to the operator, increased speed, and so forth. In embodiments in which the processing circuitry of the vehicle 10 includes a computing device, FGPA, etc., the ride settings can be adjustable by a manufacturer, an operator, and so on.

The electric vehicle 10 can further include a pair of pedals, including pedals 30a and 30b which are connected to or are part of a pedal assembly. The pedal assembly can also include a crank 60, a crank spindle (not shown), chainring (not shown), and other pedal components as can be appreciated. The electric vehicle 10 further includes a strain wave gear continuously variable transmission system 100 (or “transmission system 100”). In some embodiments, the transmission system 100 can be integrated into the frame 25, for instance, in a position proximate the pedal assembly, such as in a gearbox 55. This transmission system 100 can be configured to provide variable gear ratios for efficient power transfer from the pedals 30 and/or electric motor(s) to the wheels 35, as will be described.

The frame 25 of the electric vehicle 10 can accommodate the various components while providing structural support for the rider, as can be appreciated. The overall design of the electric vehicle 10 combines elements of a bicycle or other vehicle with electric propulsion, as will become apparent.

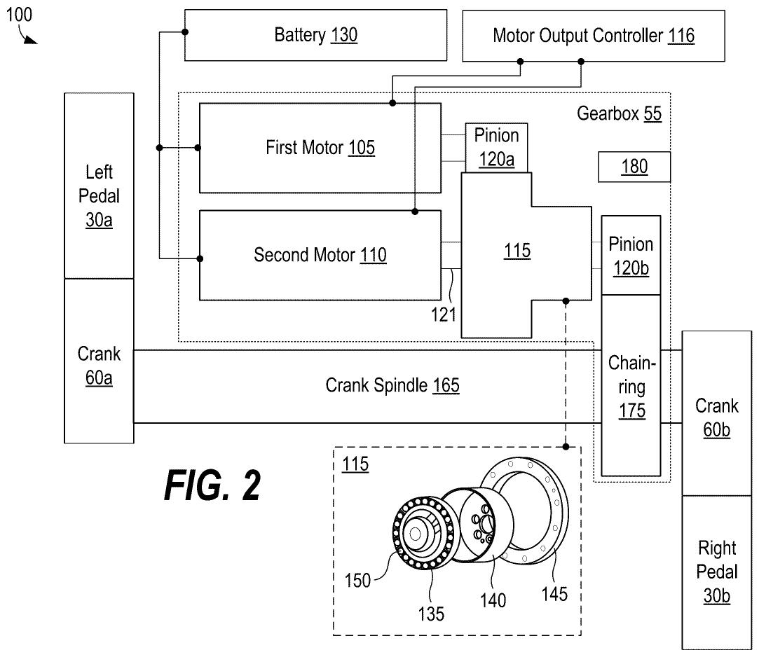

Referring to FIG. 2, a schematic block diagram of a strain wave gear continuously variable transmission system 100 for an electric vehicle 10, such as an electric bicycle, is illustrated according to various embodiments. The transmission system 100 may include, for example, a first motor 105, a second motor 110, and a strain wave gear assembly 115, motor output controller 116, among other components as will be described. In some aspects, the first motor 105 and the second motor 110 may be coupled to and positioned proximate (e.g., below) a battery 130, which can, in turn, provides power to both motors 105, 110. While only two motors 105, 110 are shown, the transmission system 100 can include two or more motors, such as two motors, three motors, four motors, and so forth, without deviating from the scope of the present disclosure. The first motor 105 and the second motor 110 are operatively connected to the motor output controller 116 (also referred to as a central control) or other processing circuitry of the vehicle 10. For instance, the motor output controller 116 can include processing circuitry of the vehicle 10 configured to control the first motor 105 and/or the second motor 110 to produce a desired output. In some embodiments, the motor output controller 116 receives an input signal from the controller 50 based on a ride setting as specified by an operator or ride, correlates the input signal to a predetermined ride setting, and outputs one of a direct current (DC) or alternating current (AC) signal to one or both of the first motor 105 and the second motor 110. This, in turn, causes the first motor 105 and/or the second motor 110 to provide predefined outputs. The outputs can include, for example, predefined speeds, torques, power, and so forth.

Further=, in some embodiments, the first motor 105 can be operatively connected to a first pinion 120a, while the second motor 110 can be operatively connected to a second pinion 120b (collectively “pinions 120”) via a shaft 121. These pinions 120a, 120b may be configured to operate with the strain wave gear assembly 115, which includes a wave generator 135, a flexspline 140, and a circular spline 145. Alternatively, the first motor 105 and/or the second motor 110 may couple directly to components of the strain wave gear assembly 115 without intervening pinions and like components.

In any event, the first motor 105 can be configured to drive the circular spline 145, which is typically static in conventional strain wave gear mechanisms. The second motor 110 can be configured to drive the wave generator 135. The flexspline 140, driven by the wave generator 135, may be configured to output power to the wheel 35a, 35b of the electric vehicle 10. In some embodiments, the flexspline 140 is operatively coupled to a chainring 175 or to a gear of a vehicle 10, either through a direct connection or via an intermediary pinion (e.g., pinion 120b), gear, and so forth, that causes movement of the wheels 35a, 35b. Processing circuitry of the motor output controller 116 can provide suitable signals (e.g., AC or DC signals) to drive the motors 105, 110 such that a desired reduction ratio is achieved. While various embodiments herein show a location of a chainring 175, in alternative embodiments, the chainring 175 can be replaced with a gear.

Based on the characteristics of the strain wave gear assembly 115, a reduction ratio can be achieved by independently controlling at least one of the first motor 105 or the second motor 110, or both. In other words, by independently controlling the first motor 105 and the second motor 110, the transmission system 100 can achieve a continuously variable set of reduction ratios, thereby providing a wide range of output speeds and/or torque settings. The dual-motor strain wave gear continuously variable transmission system 100 can thus offer a high torque capability, high gear reduction, and high efficiency out of a single stage, simplifying the design and maintenance of electric bicycles and offering variable ride settings and improving performance.

In some embodiments, the flexspline 140 is operatively connected to an output shaft, which may be part of an output shaft and pinion 120b. This configuration can allow for the transmission of power from the flexspline 140 to the wheels 35a, 35b of the electric vehicle 10 via a chainring 175 and/or crank spindle 165. The output shaft and pinion 120b may be connected to a gear, which can be an output or intermediate component in the power transmission. This arrangement can permit the transmission of power from the two motors 105, 110 through the gearing system, enabling variable speed and/or torque control and power output.

According to various embodiments, the strain wave gear assembly 115 can be integrated into a drive unit or a gearbox 55 positioned above a pedal crank assembly of the electric vehicle 10. This positioning can permit efficient power transfer from the strain wave gear assembly 115 to the wheels 35a, 35b of the electric vehicle 10. In some embodiments, the strain wave gear assembly 115 can be operatively connected to an output shaft, such as the output shaft and pinion 120. This configuration allows for the transmission of power from the flexspline 140 to the wheels 35a, 35b of the electric vehicle 10.

In some cases, a gear can be connected between the flexspline 140 and the output shaft. This gear can serve as an output or intermediate component in the power transmission. The arrangement of these components allows for the transmission of power from the two motors 105, 110 through the gearing system, enabling variable speed control and power output.

The right pedal 30b, as an example, can be operatively attached to a first crank 60a, and the first crank 60a can be operatively attached to a crank spindle 165. It is understood, however, that a second crank 60b can be operatively attached to the left pedal 30a, as shown in FIG. 2 which, in turn, can be operatively attached to the crank spindle 165. The first crank 60a and the second crank 60b are collectively referred to herein as cranks 60. In any event, the pedals 30 and the cranks 60 may drive the crank spindle 165. The wave generator 135, in some embodiments, can be driven both by the pedal 30 and the second motor 110. The crank spindle 165 can be operatively connected to the wave generator 135 such that any movement of the crank spindle 165 drives the wave generator 135. This in turn provides a reduction ratio between the crank spindle 165 and the output of the harmonic drive.

The second motor 110 can be configured to match a speed at which the crank spindle 165 is turning and thus, the system 100 can include a speed sensor 180 configured to detect a speed at which the crank spindle 165 is rotating or pedaled. Processing circuitry of the bicycle can thus adjust an output of the second motor 110 based on a measurement obtained by the speed sensor 180. The speed output by the strain wave gear assembly 115 however can be adjusted by driving the first motor 105. As a result, the operator of the e-bike can feel as if they are providing input into the system 100, while still obtaining assistance from the second motor 110.

The wave generator 135, as driven by the crank spindle 165 and/or the second motor 110, can output its rotation to the flexspline 140. The flexspline 140 can be operatively connected to the chainring 175. Thus, there can be a reduction ratio from the wave generator 135 to the flexspline 140, which can cause the chainring 175 to spin at a different speed than that of the crank 60 or the crank spindle 165. While various embodiments described herein include a reduction ratio provided between the second motor 110 and the flexspline 140, in some embodiments, a reduction ratio is provided between the crank spindle 165 and the wave generator 135, or both.

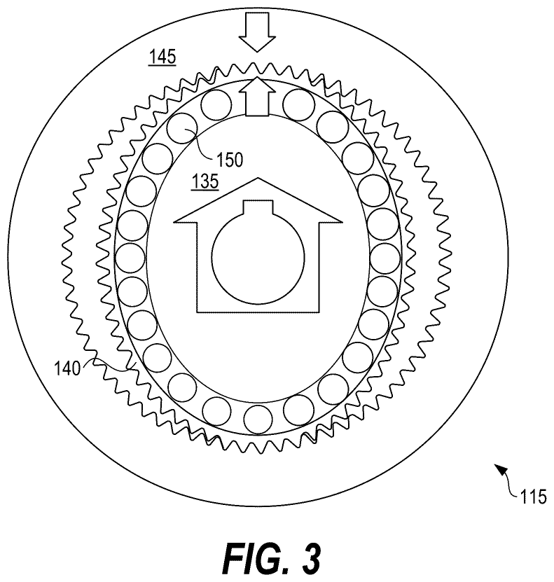

Referring to FIG. 3, a front view of a strain wave gear assembly 115, as a component of a dual-motor strain wave gear continuously variable transmission system 100, is illustrated. Generally, the assembly 115 comprises several interconnected elements that work together to provide variable reduction ratios, as will be described.

The circular spline 145 is depicted as the outermost ring of the assembly 115. The circular spline 145 includes internal gear teeth. In some aspects, the circular spline 145 is driven by the first motor 105, which is static in conventional strain wave gear mechanisms. This driving action can be achieved through a pinion gear operatively connected to the circular spline 145. By driving the circular spline 145, the reduction ratio can be reduced, essentially allowing for a continuously variable set of reduction ratios.

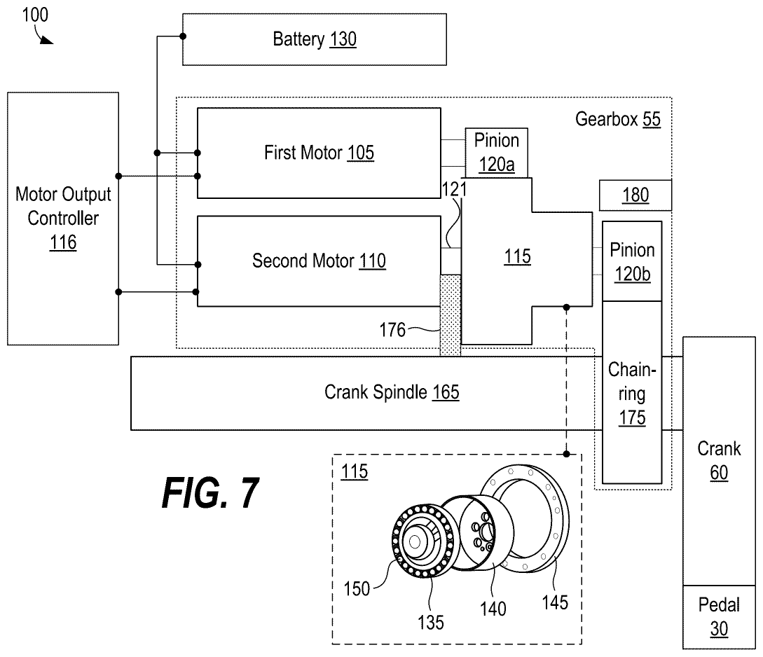

The flexspline 140 can be positioned inside the circular spline 145. The flexspline 140 can include a slightly smaller ring with external gear teeth that mesh with the internal teeth of the circular spline 145. The flexspline 140, driven by the wave generator 135, is configured to output power. In some cases, the flexspline 140 is operatively connected to an output shaft, which can be part of the output shaft and pinion 120b of FIG. 7. This configuration can permit the transmission of power from the flexspline 140 to the wheels of the electric vehicle 10, the pedals 30, and so forth.

The wave generator 135 can be positioned at the center of the strain wave gear assembly 115. The wave generator 135 can have an elliptical shape, although other potential shapes can be employed. The wave generator 135 can be driven by the second motor 110. In one embodiment, this driving action can be achieved through a gear operatively connected to the wave generator 135. In another embodiment, this driving action can be achieved through the shaft of the second motor 110 operatively connected to the wave generator 135. As the wave generator 135 rotates, the bearings 150 create a moving wave in the flexspline 140, resulting in a gear reduction between the input and output.

The wave generator 135 is surrounded by the bearings 150, which can be arranged as a series of circular bearings arranged in an elliptical pattern. These bearings 150 facilitate the rotation of the wave generator 135 within the flexspline 140. The strain wave gear assembly 115 operates by the wave generator 135 deforming the flexspline 140, causing it to engage with the circular spline 145 at specific points. As the wave generator 135 rotates, it creates a moving wave in the flexspline 140, resulting in a gear reduction between an input and output.

This configuration allows for the creation of variable reduction ratios when the circular spline 145 and wave generator 135 are driven independently by separate motors. By independently controlling the first motor 105 and the second motor 110, the system 100 can achieve a continuously variable set of reduction ratios, thereby providing a wide range of output speeds and torques.

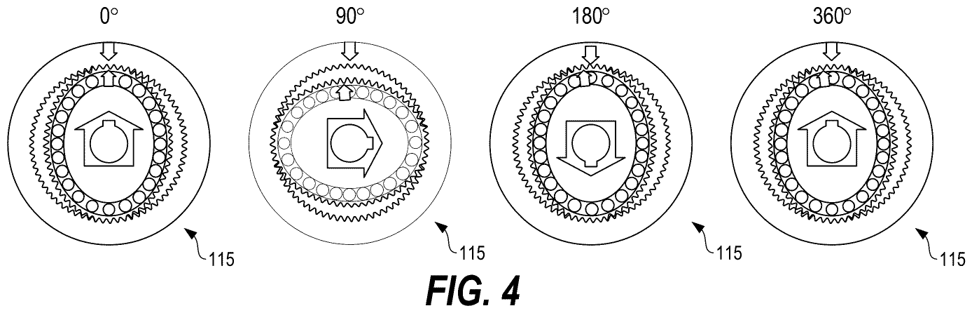

Referring to FIG. 4, a series of front views of a strain wave gear assembly 115 at different rotational positions is illustrated. Specifically, FIG. 4 shows four circular cross-sections of the assembly 115, each representing a 90-degree increment of rotation from 0 to 360 degrees. The strain wave gear assembly 115 comprises several concentric components, including a circular spline 145 with internal teeth, a flexspline 140 with external teeth that mesh with the circular spline 145, and a wave generator 135 at the center of the strain wave gear assembly 115. The wave generator 135 is surrounded by bearings 150 or like components that facilitate the rotation of the wave generator 135 within the flexspline 140.

An orientation of the wave generator 135 changes in each view of FIG. 4, demonstrating the rotation of the wave generator 135 within the strain wave gear assembly 115. At 0 degrees, a major axis of the wave generator 135 may be vertical. At 90 degrees, the major axis of the wave generator 135 has rotated clockwise, becoming horizontal. This rotation continues through 180 and 360 degrees, and so forth. As the wave generator 135 rotates, the wave generator 135 deforms the flexspline 140, causing it to engage with the circular spline 145 at different points. This mechanism allows for the transmission of rotational motion with a reduction in speed and increase in torque.

In some embodiments, the strain wave gear assembly 115 operates by the wave generator 135 deforming the flexspline 140, causing it to engage with the circular spline 145 at specific points. As the wave generator 135 rotates, it creates a moving wave in the flexspline 140, resulting in a gear reduction between the input and output. This configuration allows for the creation of variable reduction ratios when the circular spline 145 and wave generator 135 are driven independently by separate motors, such as the first motor 105 and the second motor 110. By independently controlling the first motor 105 and the second motor 110, the system 100 can achieve a continuously variable set of reduction ratios, thereby providing a wide range of output speeds. Thus, the dual-motor strain wave gear continuously variable transmission system 100 as described herein can offer a high torque capability, high gear reduction, and high efficiency out of a single stage, simplifying the design and maintenance of electric bicycles and offering variable ride settings and improving performance.

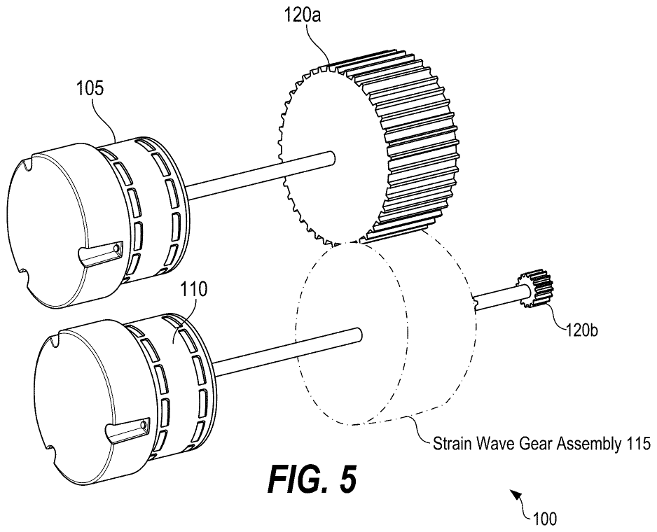

Referring to FIG. 5, an isometric view of a dual motor strain wave gear continuously variable transmission system 100 is illustrated, with various components omitted for explanatory purposes. The transmission system 100 includes the first motor 105, the second motor 110, and associated gearing components, which can interact with the strain wave gear assembly 115 The first motor 105 and/or the second motor 110 can each be coupled to a shaft extending from its center.

Pinion gears or like devices can be connected to the shafts which, in turn, can be coupled to various components of the strain wave gear assembly 115. For instance, a pinion 120a is attached to the shaft of the first motor 105, while a pinion 120b is attached to the shaft of the second motor 110. As shown in FIGS. 2 and 7, for instance, the shaft of the second motor 110 can be coupled to the strain wave gear assembly 115, which has an output coupled to the second pinion 120b. The pinions 120a, 120b can include gears with teeth around their outer edges. In some aspects, the first motor 105 is operatively connected to the circular spline 145 via the pinion 120a, while the second motor 110 is operatively connected to the wave generator 135 via a gear or the shaft of the second motor 110. This configuration allows for the transmission of power from the two motors 105, 110 through the gearing system, enabling variable speed control and power output.

The arrangement of these components allows for the transmission of power from the two motors through the gearing system, enabling variable speed control and power output. The dual motor configuration and the use of strain wave gearing provide the basis for a continuously variable transmission system. In some aspects, the first motor 105 and the second motor 110 are independently controllable to achieve a range of reduction ratios. This dual-motor strain wave gear continuously variable transmission system 100 may offer a high torque capability, high gear reduction, and high efficiency out of a single stage, simplifying the design and maintenance of electric bicycles and offering variable ride settings and improving performance.

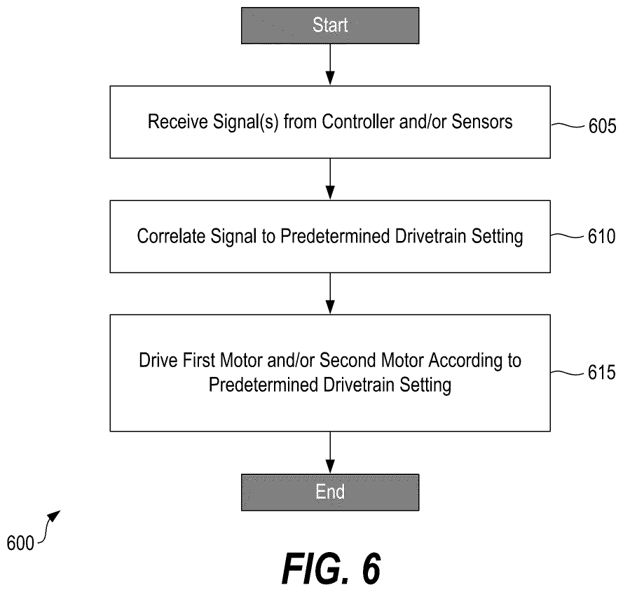

Referring to FIG. 6, a flowchart 600 depicts a process for controlling a dual motor strain wave gear continuously variable transmission system 100 which can be implemented by the motor output controller 116 or like devices. The process begins with box 605, where the motor output controller 116 receives one or more signals from a controller 50 and/or one or more sensors. The controller 50 can include the controller 50 mounted on the handlebar 40, for example, although it is understood that the controller 50 can be positioned in a multitude of locations. Additionally, other devices beyond the controller 50 can provide input signals to the motor output controller 116. The controller 50 or other components of the vehicle 10 may be configured to independently control the first motor 105 and the second motor 110 to achieve a desired reduction ratio. The sensors can include, for example, pedal speed sensors or like sensors that obtain measurements and provide a correlating signal to the motor output controller 116.

Following the receipt of the one or more signal(s), the process moves to box 610, where the one or more received signals are correlated to a predetermined setting. This setting may be based on a variety of factors, including but not limited to, the rider's input as specified by the controller 50, the pedal speed as measured by a pedal speed sensor, the current speed of the electric vehicle 10 as measured by a vehicle speed sensor, the terrain, the battery 130 level, and so forth. Next, in box 615, the first motor 105 and/or the second motor 110 are driven according to the predetermined drivetrain setting. This may involve adjusting the speed, torque, or direction of one or both of the first motor 105 and the second motor 110. The first motor 105, in some cases, drives the circular spline 145 of the strain wave gear assembly 115, which is typically static in conventional strain wave gear mechanisms. By driving the circular spline 145, the reduction ratio can be reduced, essentially allowing for a continuously variable set of reduction ratios.

Similar to the first motor 105, driving the second motor 110 may involve adjusting the speed, torque, or direction of the second motor 110. The second motor 110, in some cases, drives the wave generator 135 of the strain wave gear assembly 115. As the wave generator 135 rotates, it creates a moving wave in the flexspline 140, resulting in a gear reduction between the input and output. The first motor 105 and/or the second motor 110 can be driven until the vehicle 10 is disengaged or operation is otherwise terminated.

It is understood that the motor output controller 116 can continue to operate until further signal(s) are received from the controller 50, sensors, etc. Based on the signals as received, the motor output controller 116 can re-correlate the signals to predetermined drive settings, and drive the first motor 105 and/or the second motor 110 accordingly. This allows for dynamic adjustment of the transmission system 100 based on controller input, providing a continuously variable set of reduction ratios and a wide range of output speeds. The dual-motor strain wave gear continuously variable transmission system 100 may offer a high torque capability, high gear reduction, and high efficiency out of a single stage, simplifying the design and maintenance of electric bicycles and offering variable ride settings and improving performance.

In some aspects, the operations depicted in the flowchart 600 may be performed by processing circuitry of the controller 50. Alternatively, the operations may be performed by processing circuitry of the transmission system 100, which may be housed in a housing 20. The processing circuitry, whether located in the controller 50 or the transmission system 100, may execute instructions to carry out the steps of receiving signals, correlating signals to drivetrain settings, driving the first and second motors, and await further signals. This configuration allows for flexibility in the implementation of the control logic, enabling the system to be adapted to various design constraints or preferences.

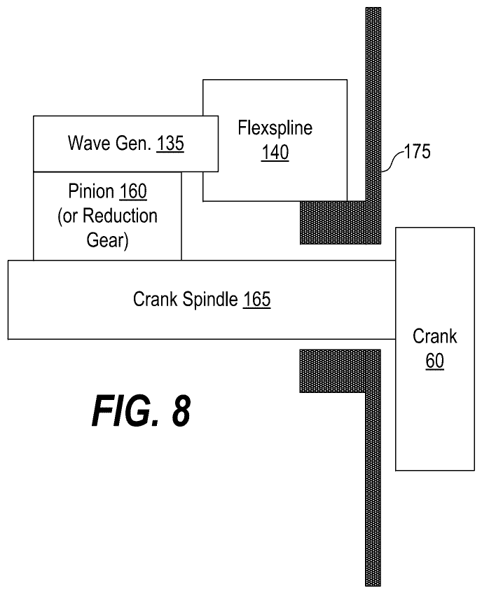

Referring to FIGS. 7 and 8, schematic block diagrams of other embodiments of a dual motor strain wave gear continuously variable transmission system 100 for an electric bicycle are illustrated. To pedal at a comfortable cadence, a rider normally uses a conventional drivetrain that includes a derailleur that shifts gears on a cassette of gears. The conventional drivetrain is manipulated to change the rotational speed of the cranks 60 relative to the wheels 35. This shifting of gears allows the rider to choose optimal power settings (e.g., force and speed settings) that the rider desires depending on riding conditions (e.g. speed, gradient, terrain, etc.). The flexspline 140 is directly connected to the chainring 175 in FIG. 8, whereas the flexspline 140 is not directly connected to the chainring 175 in FIG. 7.

According to various embodiments, the transmission system 100 can include the pedals 30, the cranks 60, the chainring 175, and the crank spindle 165. For instance, the first crank 60a can be operatively attached to the first pedal 30a, and the second crank 60b can be operatively attached to the second pedal 30b. The chainring 175 and the crank 60 can be configured to spin or otherwise move at different speeds, which can eliminate the need for a derailleur. Instead, a speed of a rear wheel of the bicycle relative to the crank 60 can be adjusted by changing the speed of the chainring 175. Unlike a conventional bicycle having a derailleur, the gearbox 55 via the second motor 110 can drive the chainring 175, where the chainring 175 does not necessarily rotate at the same speed as the crank 60.

In some embodiments, the crank 60 and a crank spindle 165 are configured to drive the wave generator 135, where the wave generator 135 has an output that drives the flexspline 140. The flexspline 140, in turn, drives or causes rotation of the chainring 175. As such, both the rider inputs (e.g., pedaling by the rider's feet) and the input from the second motor 110 contribute power to the chainring 175. The rider's input is transferred to the wave generator using reduction gear 176 or pinion 160, which in turn contributes power to the chainring 175. The reduction gear 176 or the pinion 160 can be used to match the shaft 121 rotational speed, which is operatively connected to second motor 110, to the crank spindle 165 speed. The first motor 105 can be turned on (e.g., periodically at the control of the operator) to drive a gear (e.g., pinion 120a) in such a way that it changes the rotational speed of the flexspline 140, allowing for adjustment of an output ratio to a predetermined desired output ratio.

As such, in some embodiments, the first motor 105 may be connected to a pinion 120a, while the second motor 110 may be connected to a strain wave gear assembly 115. The strain wave gear assembly 115 is detailed in inset at the bottom of FIG. 7, showing the wave generator 135, the flexspline 140, the circular spline 145, and the bearings 150 of the wave generator 135. It can be beneficial to allow an operator of a vehicle 10, such as an e-bike, with the ability to pedal and provide input to the transmission system 100, while the first motor 105 and/or the second motor 110 provide the operator with additional torque or other assistance.

Conventionally, a crank 60 of a bicycle is attached to a chainring 175, which causes the crank 60 and the chainring 175 to spin at the same speed during pedaling. In the embodiments of FIGS. 7 and 8, a crank 60 of the bicycle is not directly attached to the chainring 175, which permits the chainring 175 to rotate independent of the crank 60 and spin at a different speed relative to the crank 60. An operator can rotate the pedal 30 which causes the crank 60 to rotate, and the crank spindle 165 to also rotate. The crank spindle 165 can drive the wave generator 135 via the reduction gear 176 or pinion 160 operatively connected to the shaft 121 of the second motor 110. The second motor 110 can also be configured to drive the wave generator 135 at the same time through shaft 121 as well.

The pedal 30 can be operatively attached to the crank 60, and the crank 60 can be operatively attached to the crank spindle 165. Thus, the pedal 30 and the crank 60 may drive the crank spindle 165. The wave generator 135, in some embodiments, can be driven both by the pedal 30 and the second motor 110. While not shown in FIGS. 7 and 8, it is understood that the pedal 30 can include a pedal spindle.

In some embodiments, the second motor 110 is configured to match a speed at which the crank spindle 165 is turning. To this end, the system 100 can include a speed sensor 180 configured to detect a speed at which the crank spindle 165 is rotating or pedaled. Processing circuitry of the bicycle can thus adjust an output of the second motor 110 based on a measurement obtained by the speed sensor 180. As a result, the operator of the e-bike can feel as if they are providing input into the system 100, while still obtaining assistance from the second motor 110.

The wave generator 135, as driven by the crank spindle 165 and/or the second motor 110, can output its rotation to the flexspline 140. The flexspline 140 can be attached to the chainring 175. Thus, there can be a reduction ratio from the wave generator 135 to the flexspline 140, which can cause the chainring 175 to spin at a different speed than that of the crank 60 or the crank spindle 165.

When the first motor 105 is static (i.e. not operating or providing any assistance), the circular spline 145 is not turning or being driven by the first motor 105. Thus, a fixed reduction ratio is provided based on outputs of the wave generator 135 and the flexspline 140. When the operator wishes to speed up or otherwise cause the chainring 175 to accelerate, the controller 50 can drive the first motor 105 which, in turn, drives the circular spline 145. This will cause the flexspline 140 to turn more quickly, which causes the chainring 175 to also turn more quickly. As a result, movement of the chainring 175 is not directly linked to a speed of movement of the crank 60.

The output from the strain wave gear assembly 115 can be transmitted through an output pinion 120b. The output pinion 120b can be operatively connected to the chainring 175, which in turn can be operatively connected to the crank 60. The chainring 175 may normally move at the same rate as the crank 60 on a conventional bike, but in some aspects, the chainring 175 can be installed to link only directly to the motor output and spin at a different speed as the crank 60. Thus, movement of a rear wheel (or other wheel) of an e-bike or other vehicle 10 can be driven via the chainring 175. FIG. 8 further illustrates that the chainring 175 is not directly linked to the crank spindle 165 which permits the chainring 175 to rotate at a speed different than that of the crank spindle 165 or crank 60. One of the crank spindle 165 and the second motor 110 that drive the wave generator 135 can have a form of reduction gear in between them to ensure that they are spinning at the same speed as the second motor 110 may be unable to spin at 60 rpm to 80 rpm, for example, which is a common speed for a crank 60 to spin.

In some aspects, the strain wave gear continuously variable transmission system 100 may find applications beyond electric bicycles. For instance, the system 100 may be utilized in automotive drivetrains. The high torque capability, high gear reduction, and high efficiency of the system 100 could be beneficial in vehicles requiring variable speed control and power output. The system 100 may provide a more efficient and compact solution compared to traditional transmission systems, potentially reducing the overall size and weight of the drivetrain.

In some cases, the strain wave gear continuously variable transmission system 100 may eliminate the need for a rear derailleur in bicycles. The system 100, by providing a continuously variable set of reduction ratios, may simplify the design of bicycles and bicycle components. This could reduce the complexity of the drivetrain, potentially leading to lower maintenance requirements and costs.

In some aspects, the strain wave gear continuously variable transmission system 100 may be integrated into a BiModal mid-drive unit. The system 100 could replace the standard gear train in such units, potentially simplifying the design and reducing the number of components. This can lead to a more compact and lightweight drive unit, potentially improving the overall performance and efficiency of the vehicle. In some cases, the strain wave gear continuously variable transmission system 100 may provide a quieter drive unit compared to standard gear trains. The system 100, by utilizing strain wave gearing, may operate with less noise and vibration. This can the user experience, particularly in applications where noise reduction is desirable, such as in residential areas or during night-time operation.

The strain wave gear continuously variable transmission system 100 may be adapted for use in various electric vehicles beyond bicycles. For example, the system 100 may be implemented in electric scooters, providing efficient power delivery and smooth acceleration across a range of speeds. The compact nature of the system 100 may make it suitable for integration into the limited space available in e-scooter designs.

The system 100 may also find applications in electric skateboards and electric longboards. In these vehicles, the precise control of speed and torque offered by the dual-motor configuration could enhance rider experience and safety. The system's ability to provide a wide range of reduction ratios may be particularly beneficial for tackling various terrains and inclines encountered in skateboarding.

In some cases, the strain wave gear continuously variable transmission system 100 may be adapted for use in electric wheelchairs. The system's high torque capability and efficient power delivery could improve maneuverability and extend battery life in these mobility devices. The smooth, stepless power delivery may also enhance comfort for wheelchair users.

The system 100 may also be suitable for integration into electric golf carts. The variable reduction ratios could provide improved performance across different course terrains, from flat fairways to steep hills. The quiet operation of the strain wave gear mechanism may be particularly advantageous in maintaining the serene atmosphere of golf courses.

In some aspects, the system 100 may be scaled for use in larger electric vehicles such as neighborhood electric vehicles (NEVs) or low-speed electric vehicles (LSEVs). These vehicles, often used in planned communities or campus environments, could benefit from the efficient power delivery and smooth acceleration provided by the strain wave gear continuously variable transmission system 100.

The processing circuitry described herein, including processing circuitry of the controller 50, can include application-specific integrated circuits (ASICs), which are custom-designed integrated circuits tailored for specific functions of the strain wave gear continuously variable transmission system 100. ASICs can offer high performance and energy efficiency for dedicated tasks.

In some embodiments, however, the processing circuitry can incorporate field-programmable gate arrays (FPGAs), which are reconfigurable integrated circuits that can be reprogrammed to perform different functions. FPGAs can provide flexibility in adapting the system to different requirements or updates, while permitting adjustment of predetermined torque settings (or predetermined motor drive settings that create predetermined torque ratios).

The processing circuitry can also include system-on-chip (SoC) devices, which integrate multiple components such as processors, memory, and peripherals onto a single chip. SoCs can offer a compact and efficient solution for implementing the control logic of the transmission system 100. In some embodiments, the processing circuitry can utilize microcontrollers, such as computers on a single integrated circuit containing a processor, memory, and programmable input/output peripherals. Microcontrollers can be suitable for embedded applications in the electric vehicle 10 or the controller 50. The processing circuitry can also include memory devices such as random-access memory (RAM), read-only memory (ROM), or non-volatile memory (e.g., flash memory) to store non-transitory computer-readable instructions and data for the processors. These memory components can be integrated with the processors or can be on separate chips.

In some cases, the processing circuitry may incorporate specialized neural processing units (NPUs) or tensor processing units (TPUs) for machine learning and artificial intelligence tasks, which may be used for adaptive control of the transmission system 100. The processing circuitry can also include various interface components such as analog-to-digital converters (ADCs), digital-to-analog converters (DACs), and communication interfaces (e.g., UART, SPI, I2C, CAN) to interact with sensors, actuators, and other components of the electric vehicle 10.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An electric bicycle, comprising:
a frame;
a wheel coupled to the frame;
a continuously variable transmission system (CVT) mounted to the frame, the continuously variable transmission system comprising:
a first motor;
a second motor; and
a strain wave gear mechanism operatively connected to both the first motor and the second motor, wherein the strain wave gear mechanism comprises a circular spline driven by the first motor, a wave generator driven by the second motor, and a flexspline configured to output power to the wheel.

2. The electric bicycle of claim 1, further comprising a controller configured to control the first motor and the second motor to achieve a desired reduction ratio.

3. The electric bicycle of claim 1, further comprising a chainring and a crank, wherein the strain wave gear mechanism is operatively coupled to the chainring, and the chainring and the crank are configured to spin at different speeds.

4. The electric bicycle of claim 1, wherein the first motor is operatively connected to the circular spline.

5. The electric bicycle of claim 1, further comprising a controller configured to perform at least one of: adjusting a gear ratio output by the transmission system by correspondingly driving the first motor, providing power to assist an operator pedal by correspondingly driving the second motor, or a combination thereof.

6. A continuously variable transmission (CVT) system, comprising:
a first motor;
a second motor; and
a strain wave gear mechanism operatively connected to both the first motor and the second motor,
wherein the strain wave gear mechanism includes a circular spline, a wave generator, and a flexspline, and wherein the first motor is configured to drive the circular spline and the second motor is configured to drive the wave generator to provide variable reduction ratios.

7. The continuously variable transmission system of claim 6, wherein the first motor is operatively connected to the circular spline.

8. The continuously variable transmission system of claim 6, wherein the flexspline is operatively connected to an output shaft.

9. The continuously variable transmission system of claim 8, further comprising a gear connected between the flexspline and the output shaft.

10. The continuously variable transmission system of claim 6, further comprising a motor output controller configured to perform at least one of: adjusting a gear ratio output by the transmission system by correspondingly driving the first motor, providing power to assist an operator pedal by correspondingly driving the second motor, or a combination thereof.

11. The continuously variable transmission system according to claim 6, further comprising a chainring and a crank, wherein the strain wave gear mechanism is operatively coupled to the chainring, and the chainring and the crank are configured to spin at different speeds.

12. The continuously variable transmission system according to claim 11, further comprising a controller configured to adjust a rotational speed of the chainring by adjusting a speed of the first motor.

13. The continuously variable transmission system according to claim 10, wherein an operation of the motor output controller is based at least in part on at least one input signal received from a user-operated controller and a sensor, wherein the sensor comprises a speed sensor or a pedal speed sensor.

14. The continuously variable transmission system according to claim 6, further comprising a crank spindle operatively connected to the wave generator, wherein movement of the crank spindle drives the wave generator, wherein a reduction ratio is provided between at least one of: the second motor and the flexspline, the crank spindle and the flexspline, or a combination thereof.

15. A continuously variable transmission (CVT) system, comprising:
a first motor, a second motor, and a crank spindle; and
a strain wave gear mechanism operatively connected to the first motor, the second motor, and the crank spindle,
wherein the strain wave gear mechanism includes a circular spline, a wave generator, and a flexspline, and
wherein the first motor is configured to drive the circular spline and at least one of the second motor and the crank spindle is configured to drive the wave generator to provide variable reduction ratios.

16. The continuously variable transmission system according to claim 15, wherein the strain wave gear mechanism is operatively coupled to a chainring or a gear.

17. The continuously variable transmission system according to claim 15, further comprising a crank, wherein a chainring and the crank are configured to spin at different speeds.

18. The continuously variable transmission system according to claim 15, further comprising a controller configured to adjust a rotational speed of a chainring by adjusting a speed of the first motor.

19. The continuously variable transmission system according to claim 15, further comprising a controller configured to perform at least one of: adjusting a gear ratio output using the first motor, providing power to assist an operator pedal using the second motor, or a combination thereof.

20. The continuously variable transmission system according to claim 15, wherein movement of the crank spindle drives the wave generator, and a reduction ratio is provided between the second motor and the flexspline, between the crank spindle and the flexspline, or a combination thereof.
